(19) United States
(12) Patent Application Publication
(10) Pub. No.: US 2014/0255651 A1
(43) Pub. Date: Sep. 11, 2014

(54) SOYBEAN OIL IN HIGH HARDNESS RUBBER FORMULATIONS FOR AUTOMOTIVE GLASS RUN WEATHERSTRIPS AND METHOD

(71) Applicant: COOPER-STANDARD AUTOMOTIVE INC., Novi, MI (US)

(72) Inventors: Krishnamachari Gopalan, Troy, MI (US); Robert J. Lenhart, Fort Wayne, IN (US)

(73) Assignee: COOPER-STANDARD AUTOMOTIVE INC., Novi, MI (US)

(21) Appl. No.: 13/787,109

(22) Filed: Mar. 6, 2013

(51) Int. Cl. B60J 10/00; B60J 10/04

(52) U.S. Cl. CPC B60J 10/0002; B60J 10/042
USPC 428/156; 524/300

(57) ABSTRACT

A weatherstrip is configured for engagement with an associated vehicle window. A body of the weatherstrip has regions of high hardness that include soybean oil as an ingredient in the rubber formulation. Flexible seal portions extend outwardly from the body and are adapted for sliding engagement with the associated vehicle window. Preferably, the soybean oil is approximately 1-25 weight % of the rubber formulation in the high hardness regions. The body has a Shore A durometer on the order of 80-95. A method of forming the weatherstrip includes providing a rubber formulation and substituting at least a portion of a plasticizer with fully hydrogenated soybean oil.

### BACKGROUND

This disclosure is directed to a weatherstrip, and more particularly to a glassrun weatherstrip that operatively engages perimeter edge portions of a movable vehicle window. However, the disclosure may find application in related environments and applications encountering the same types of issues and end use requirements.

One end result of a glassrun weatherstrip focuses on producing a very rigid vulcanized rubber compound that provides structural support for automotive weatherstrips. High durometer, dense, formulations developed for glassrun weatherstrips are typically achieved by using, for example, highly crystalline EPDM polymers and/or addition of hardening agents like phenolic novolac resin and organic amines like Hexa-80 (hexamethylenetetramine).

Existing plasticizers incorporated into high hardness rubber formulations used in connection with the manufacture of glass run weatherstrips typically include paraffinic or napthenic oil. However, there are supply constraints associated with paraffinic oil. Being a petroleum-based oil leads to fluctuations in both supply and cost. Thus, control over both the supply and cost would be advantageous, and any ability to reduce the amount of petroleum-based oil in the final product is desirable.

There is always a desire to improve the performance of the glassrun weatherstrip, for example, increased hardness, lower cost, renewable resource, etc. However, material properties of the cured weatherstrip can suffer when high crystalline EPDM polymer is used to raise the hardness level. The highly crystalline polymers unfortunately encounter issues with compression set, i.e., pressure applied to the surface of the weatherstrip body leaves an indent or impression in the body which can be permanent, and thereby prevents the weatherstrip from properly supporting and/or sealing in that region. Therefore, it would be desirable to develop a rubber formulation for such use that reduces or eliminates the use of one or more crystalline polymers.

In addition, other hardening agents can produce low levels of formaldehyde which is undesirable. Thus, other select hardening agents are avoided for such reasons.

Another option is to incorporate a metal carrier into the glassrun weatherstrip assembly. For example, it is common to use a rigid metal carrier such as aluminum or steel that provides desired strength and rigidity to the final weatherstrip. For example, the carrier may be lanced or formed in a manner that allows for ease of bending as the weatherstrip must be able to conform to a radius of curvature. Metal carriers though are undesirable in glassrun weatherstrips because of the increased weight that the metal carrier contributes to the vehicle. Increased weight is detrimental to fuel economy. Further, metal is generally more expensive than rubber so that eliminating the metal carrier and replacing it with rubber is desirable as long as the performance characteristics are not substantially adversely impacted.

Thus, a need exists for a rubber formulation that still provides the desired performance characteristics, including high hardness, and yet is made at least in part from a renewable resource.

### SUMMARY

A weatherstrip configured for engagement with an associated vehicle window is provided that is at least partly formed from a renewable (“green”) oil, preferably soybean oil that has been completely hydrogenated.

A body of the weatherstrip includes regions having a high hardness. The high hardness regions including soybean oil as an ingredient in the body. Flexible seal portions extend outwardly from the body and are adapted for sliding engagement with the associated vehicle window.

The soybean oil is preferably approximately 1-25 weight % of a material forming the body.

The material forming the body is a rubber formulation, that typically includes an EPDM polymer.

The body has a Shore A durometer on the order of 80-95.

The body is free of a carrier.

A method of forming a weatherstrip exhibiting high hardness is disclosed herein.

The method includes providing a rubber formulation, and substituting at least a portion of a plasticizer with fully hydrogenated soybean oil.

The substituting step includes melting the fully hydrogenated soybean oil, and mixing the liquid fully hydrogenated soybean oil into the rubber formulation at the same time in a mixer.

The fully hydrogenated soybean oil is substituted at a rate of approximately 1-25% weight of the total weight in the method.

The method further includes curing the rubber formulation containing the fully hydrogenated soybean oil, and the cured weatherstrip having a Shore A durometer on the order of 80-95.

Preferably the mixing of the liquid fully hydrogenated soybean oil into the rubber formulation occurs at a temperature around 150 degrees F. or greater, for example, the mixing in one preferred arrangement occurring at temperatures ranging from about 250 degrees F. to approximately 320 degrees F.

The method includes at least one of eliminating a carrier from the weatherstrip, omitting or reducing highly crystalline polymers from the mixture, and omitting or reducing hardening agents from the mixture.

One benefit is associated with the high durometer of the resulting weatherstrip.

Another advantage resides in the light weight of the weatherstrip.

Still another benefit is the ability to incorporate a renewable resource in the elastomeric material that forms at least a portion of the weatherstrip.

Yet another advantage is associated with the improved fuel economy that results from eliminating the use of a metal carrier in the weatherstrip.

Still other benefits and advantages will become apparent upon reading and understanding the following detailed description.

### BRIEF DESCRIPTION OF THE DRAWINGS

FIG. 1 shows an automotive vehicle having glass run weatherstrip.

FIG. 2 is a cross-sectional view of a glassrun weatherstrip taken along a belt line of the automotive vehicle.

FIG. 3 is a cross-sectional view taken below the belt-line of the window opening.

FIG. 4 is a flowchart of the general steps associated with manufacture of the weatherstrip.

FIG. 5 is a table of six rubber formulations with varying amounts of soybean oil.

FIG. 6 is a graphical illustration of the durometer versus the weight percent of soybean oil.

FIGS. 7 and 8 are graphical illustrations of rheometer curves (torque versus time) for partially hydrogenated soybean oil and fully hydrogenated soybean oil in EPDM rubber, respectively.

FIG. 9 is a graphical representation of the thermal stability for soybean oil relative to paraffinic oil.

FIG. 10 is a graphical representation of the heat flowability relative to temperature for a soybean-based rubber compound.

### DETAILED DESCRIPTION

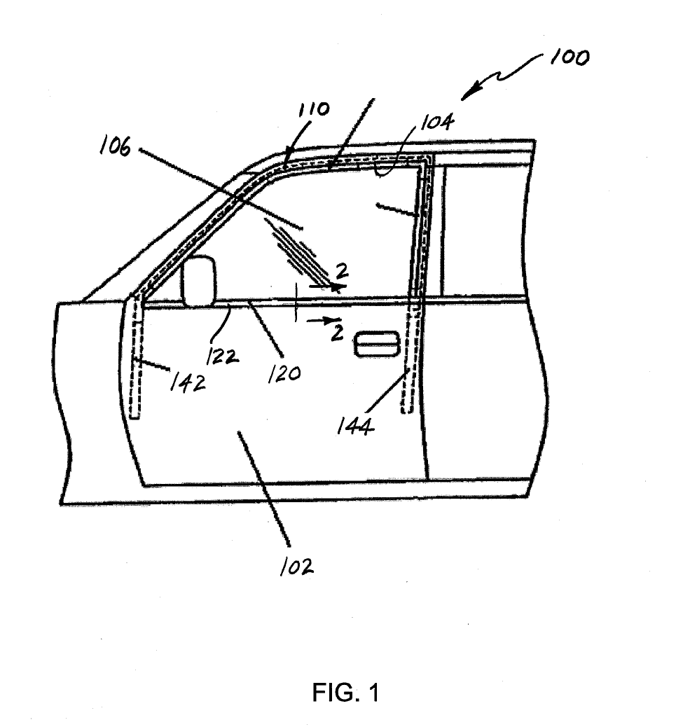

FIG. 1 shows a portion of an automotive vehicle 100, for example, a front door 102 that includes a window opening 104 and a window 106 that is selectively raised and lowered relative to the door. A weatherstrip 110 surrounds selective perimeter portions of the window (sides and upper portion when the window is closed). This weatherstrip 110 is oftentimes referred to as a glass run weatherstrip. The weatherstrip 110 may be formed as separate weatherstrip portions that engage different perimeter portions of the window and in some instances the weatherstrip portions are integrally joined together as a module or a single weatherstrip assembly. The teachings of the present disclosure are applicable whether used in separate weatherstrip portions or in an integrated module.

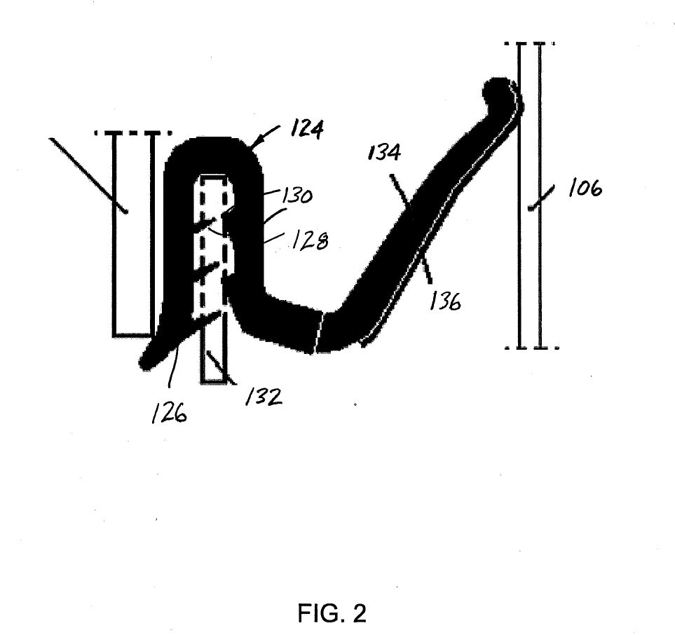

A lower edge of the window opening as defined by the door is often referred to as a beltline 120. Extending along the beltline 120 is a beltline weatherstrip portion or beltline portion of the weatherstrip module identified as 122. A cross-sectional view of the beltline weatherstrip 122 is shown in FIG. 2. The beltline weatherstrip 122 includes a body 124 formed as an inverted, generally U-shaped component in cross-section having first and second legs 126, 128 having inwardly extending gripping portions 130 that engage a door panel 132. The beltline weatherstrip 122 further includes a seal lip 134 that is flexible relative to the body, and is oftentimes formed of a different material (e.g. lower durometer rubber or plastic) than the rubber or EPDM polymer composition of the body 124. A low friction material 136 is typically provided along that portion of the seal lip 134 that is configured for sliding engagement with the movable vehicle door window 106. It is not uncommon for the beltline weatherstrip 122 to be formed as a co-extruded structure where the different regions or portions of the integrated beltline weatherstrip are formed from different materials in order to serve different functions. For example, the body 124 may be a higher durometer material while the seal lip 134 requires flexibility and thus is preferably a lower durometer material that may also incorporate a low friction material.

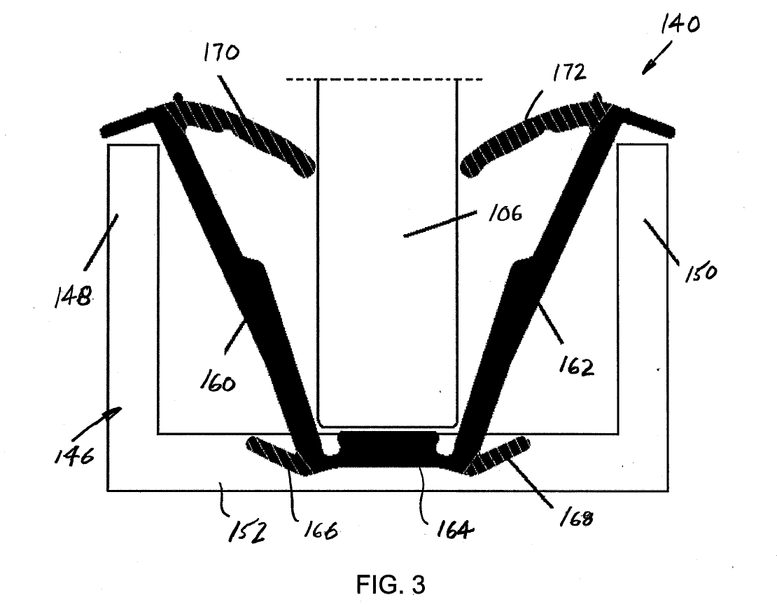

Illustrated in FIG. 3 is a cross-sectional view of another or below belt weatherstrip portion 140 of the glassrun weatherstrip 100. For example, below belt portions 142, 144 located in an interior cavity of the door 102 may have a configuration as generally illustrated in FIG. 3. Specifically, the below belt weatherstrip portion has an outer rigid support member 146 shown here as a generally U-shaped component that receives or supports the below belt weatherstrip portion 140. Upstanding legs 148, 150 form a channel with base 152 that receives the weatherstrip portion 140. The weatherstrip portion 140 is unsupported, i.e., it does not have a rigid support member encased within the rubber or EPDM polymer of which the weatherstrip portion is made. First and second legs 160, 162 extend generally upwardly and outwardly from a base portion 164 so that this below belt weatherstrip portion 140 likewise has a generally U-shaped conformation adapted to receive a perimeter edge of the window 106. Retaining flanges 166, 168 are provided along outer edges of the base portion 164 while flexible seal lips 170, 172 are flexibly joined at outer ends of the respective legs 160, 162. Again, the flexible seal lips 170, 172, and even the retaining flanges 166, 168 may be formed of a different material than the remaining rubber of the weatherstrip portion 140. Further, those portions of the body (comprised of legs 160, 162 and base 164) that are adapted to engage the window 106 preferably have a hardened surface, while the seal lips 170, 172 may have a low friction surface where the seal lips engage the window edge.

Although not specifically illustrated or described, other configurations of the weatherstrip and particularly a glassrun weatherstrip (e.g., portions along the header or pillar) may have different conformations but still require hardened regions that abut with perimeter edges of the movable window so that the teachings of the present disclosure are fully applicable.

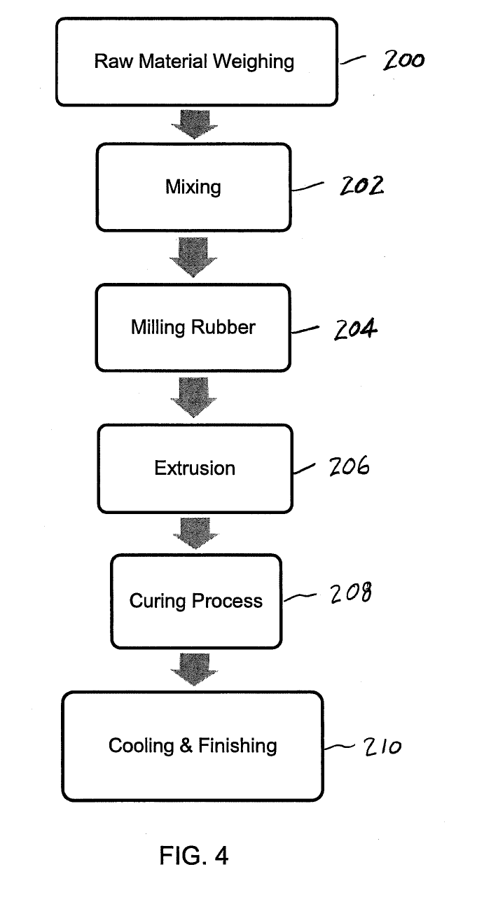

FIG. 4 is a general illustration of the steps involved in preparation of the rubber or EPDM polymer formulation used in manufacturing the above-described glassrun weatherstrips. Particularly, step 200 generally refers to the combining of various raw materials i.e. weighing desired amounts of the components that constitute the rubber formulation. These components are subsequently mixed as represented in step 202 and then the mixed compound or rubber is milled as represented in step 204. The rubber is subsequently formed into a desired shape or configuration, for example as illustrated in the weatherstrips described in connection with FIGS. 1-3. One common method of forming the weatherstrip is by extrusion as represented at step 206. Thereafter, the extruded weatherstrip is cured as noted in step 208 and subsequently cooled and finished at step 210. There may be more or less steps to the rubber formulation and weatherstrip formation processes, but this flowchart provides a general outline of the procedure.

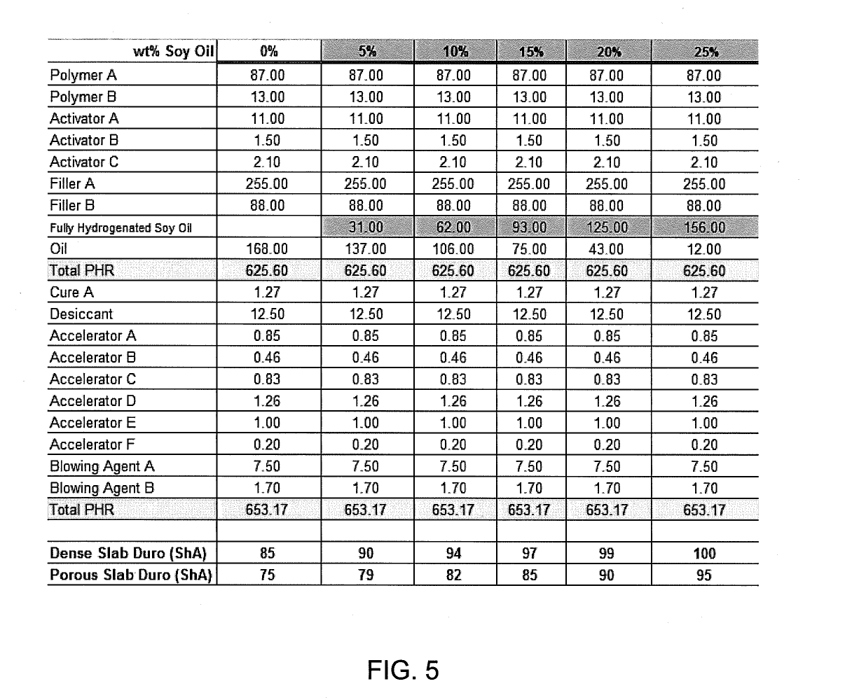

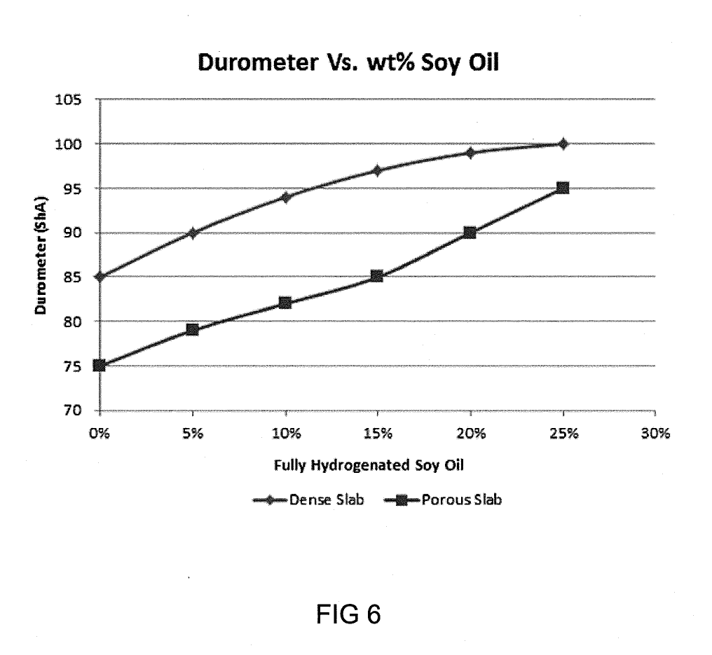

FIG. 5 is a table that shows six (6) different formulations. The key distinction between the different formulations is the substitution of different amounts of soybean oil (also occasionally referred to as soy oil) for a typical oil (i.e., petroleum-based oil such as paraffinic or napthenic oil, although these are not the only types of petroleum-based oils used in rubber formulations) in the rubber or EPDM polymer formulation. As is evident, the remainder of the components in each of the six formulations remains constant and the soybean oil is increased in 5% increments (from 0% to 25% by weight) substituted for the petroleum-based oil (i.e., the petroleum-based oil is replaced with soybean oil). The durometer or shore A hardness of the resulting material is also provided in the table of FIG. 5. In addition, the durometer is graphically represented relative to the percent of soybean oil in FIG. 6. Further, data is provided relating to a dense slab and a porous slab to illustrate that the present disclosure applies to formulations that use a blowing agent, as well as rubber formulations that do not use a blowing agent. That is, if a foaming or blowing agent is added to the rubber formulation to create air pockets that expand during the curing process, then the resulting material is referred to as a porous slab. On the other hand, if the blowing agent is omitted and the rubber is cured under pressure to limit the formation of air cells, then the resulting material is referred to as a dense slab and generally has a higher durometer than the porous slab. As is evident from FIG. 6, the durometer increases with the increasing percentage of soybean oil substituted for the petroleum-based oil, ranging from a shore A hardness of approximately 90 for 5 weight % of soybean oil to a shore A value of 100 for 25 weight % of soybean oil in the rubber formulation.

One important distinction is that the soybean oil is preferably fully hydrogenated. For purposes of this disclosure, “fully hydrogenated” means at least greater than 95% hydrogenated (since testing demonstrated that 95% hydrogenation did not provide acceptable results) and up to and including 100% hydrogenation, and partially hydrogenated means 95% and below. As is well-known, hydrogenation is a chemical reaction of treating a compound with hydrogen (H₂) which results in a reduced or saturated organic compound. Typically, pairs of hydrogen atoms are added as a result of the process. This changes the physical state of the soybean oil from a liquid to a solid. Thus when the fully hydrogenated soybean oil is added to the rubber formulation, it is necessary to heat the formulation above the melting point (150° F.).

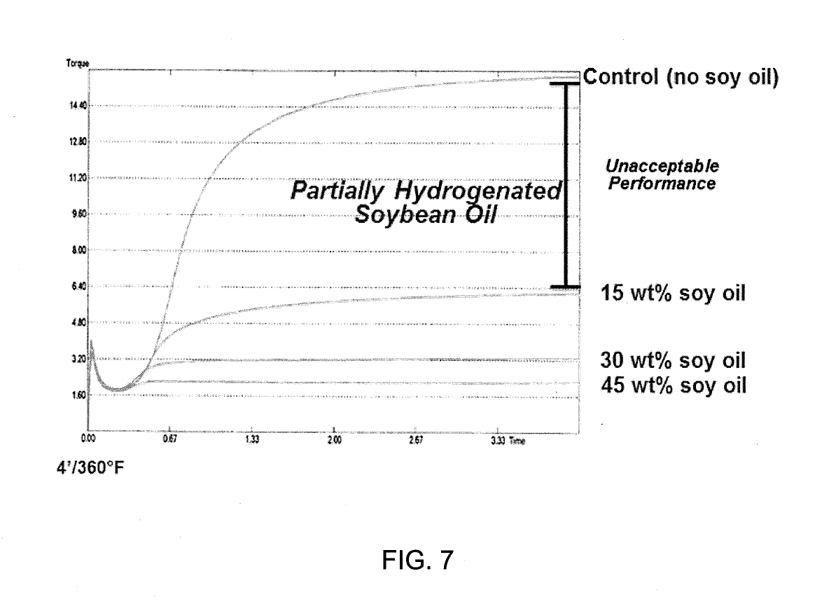

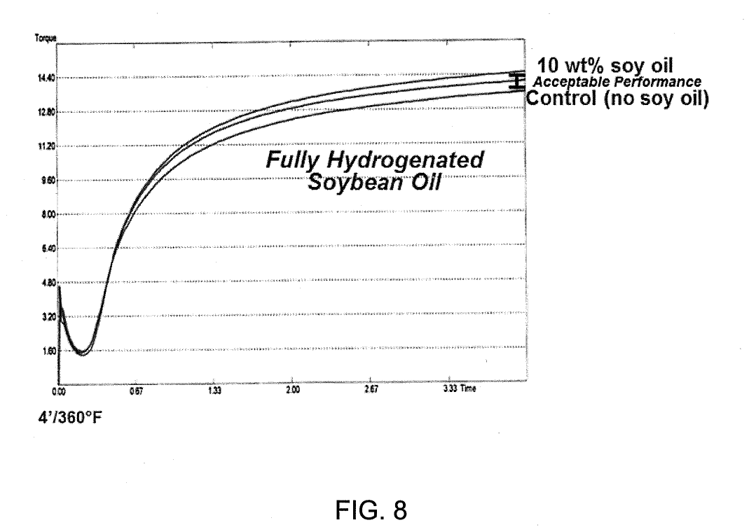

As illustrated in FIGS. 7 and 8, the rheological performance examples are graphically represented relative to the control sample (i.e., no soybean oil). When the soybean oil is only partially hydrogenated, the torque is outside the acceptable parameters of the control example (i.e., no soybean oil) as evidenced in FIG. 7. However, when the soybean oil is fully hydrogenated, the torque is encompassed within acceptable parameters of the control example (i.e., no soybean oil) as evidenced in FIG. 8. The same is true of other weight percentages of soybean oil when fully hydrogenated.

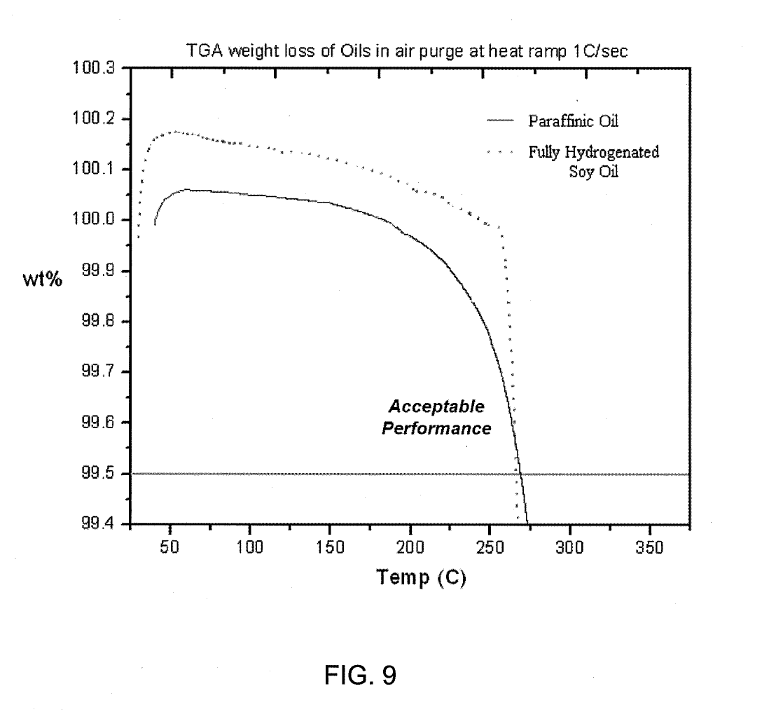

Further, the performance of the resultant compounds was also measured over a range of temperatures from approximately 50 to 275° C. As graphically illustrated in FIG. 9, the compounds with fully hydrogenated soybean oil exhibit similar performance characteristics to the paraffinic oil-based rubber formulation (i.e., no soybean oil).

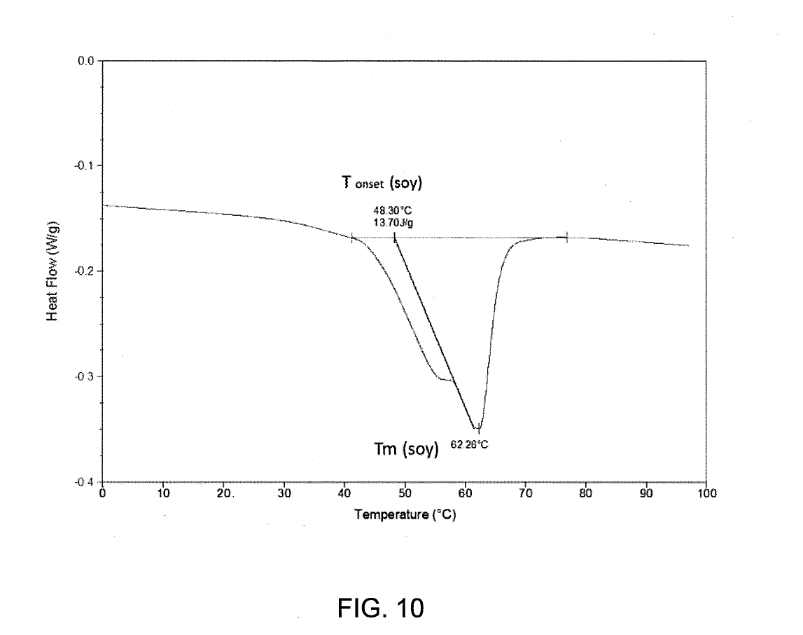

As previously noted, the fully hydrogenated soybean oil is solid at room temperature. However when heated, it becomes liquid, i.e., the fully hydrogenated soybean oil has a heat flow as graphically evidenced in FIG. 10. In this manner, the batch is heated during the mixing process and the fully hydrogenated soybean oil is more easily distributed throughout the rubber formulation because the fully hydrogenated soybean oil is a liquid. In preferred embodiments, this mixing step occurs at temperatures ranging from approximately 250 degrees F. to approximately 320 degrees F., well above the 150 degree F. melting temperature of the fully hydrogenated soybean oil.

The present disclosure allows substantially similar performance characteristics to be achieved by using fully hydrogenated soybean oil to raise hardness without the use of highly crystalline the EPDM polymers, hardening agents, or metal carrier. The end result is a high durometer, lightweight glass run weatherstrip with improved material properties to help meet the demands for improved fuel economy and utilization of renewable resources.

Since soybean oil is liquid at room temperature, it can be hydrogenated to remove unsaturation. The hydrogenation process converts the oil from a liquid to a solid at room temperature; however, fully hydrogenated soybean oil begins to melt around 150° F. so it is easily incorporated into the rubber matrix during mixing. Fully hydrogenated soybean oil is required for this disclosure to prevent unsaturation in the soybean oil from interfering with cross-linking when vulcanizing the rubber. The soybean oil solidifies to raise hardness once the vulcanized weatherstrip is cooled to temperatures below 150° F.

This disclosure uses the fully hydrogenated soybean oil to raise hardness without the use of highly crystalline the EPDM polymers, hardening agents, or metal carrier, which features can be either reduced or omitted entirely. As is evident from the test samples, the level of hardness can be adjusted by simply increasing or reducing the ratio of petroleum-based oil to hydrogenated soybean oil in the EPDM weatherstrip formulation. For example, a lower petroleum-based oil to soybean oil ratio will raise the durometer/hardness of the EPDM rubber compound hence increasing the stiffness of the glassrun weatherstrip. The end result is a high durometer, lightweight weatherstrip with improved material properties.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. (canceled)

2. A weatherstrip configured for engagement with an associated vehicle window, the weatherstrip comprising:
a body having regions of a high hardness, the high hardness regions including soybean oil as an ingredient in the body wherein the soybean oil comprises approximately 1-25 weight % of a material forming the body and the soybean oil is fully hydrogenated; and
flexible seal portions extending outwardly from the body adapted for sliding engagement with the associated vehicle window.

3. The weatherstrip of claim 2 wherein the material forming the body is rubber.

4. The weatherstrip of claim 3 wherein the body has a Shore A durometer on the order of 80-95.

5. The weatherstrip of claim 1 wherein the body is free of a carrier.

6-19. (canceled)

20. A weatherstrip made by the process of providing a rubber formulation; and
substituting at least a portion of a plasticizer with fully hydrogenated soybean oil.

21. A weatherstrip comprising:
a body having regions of a high hardness and at least one flexible seal portion connected to the body, at least the high hardness regions including soybean oil as an ingredient in the body wherein the soybean oil is fully hydrogenated.

22. The weatherstrip of claim 21 wherein the material forming the body is rubber.

23. The weatherstrip of claim 22 wherein the body has a Shore A durometer on the order of 80-95.

24. The weatherstrip of claim 21 wherein the body is free of a carrier.

25. The weatherstrip of claim 21 wherein the soybean oil comprises approximately 1-25 weight % of a material forming the body.

26. The weatherstrip of claim 21 wherein the body is a generally U-shaped component in cross-section.

27. The weatherstrip of claim 26 wherein the body has first and second legs forming the generally U-shaped component and gripping portions extending inwardly from the body for gripping an automotive component.

28. The weatherstrip of claim 21 wherein the flexible seal portion includes a seal lip formed of a different material than the body.

29. The weatherstrip of claim 28 further comprising a low friction material along a portion of the seal lip.

30. The weatherstrip of claim 21 wherein the flexible seal portion is formed of a rubber or plastic material that has a lower durometer than the body.

31. The weatherstrip of claim 1 wherein the body is a generally U-shaped component in cross-section.

32. The weatherstrip of claim 31 wherein the body has first and second legs forming the generally U-shaped component and gripping portions extending inwardly from the body for gripping an automotive component.

33. The weatherstrip of claim 1 wherein the flexible seal portion includes a seal lip formed of a different material than the body.

34. The weatherstrip of claim 33 further comprising a low friction material along a portion of the seal lip.

35. The weatherstrip of claim 33 wherein the seal lip is formed of a rubber or plastic material that has a lower durometer than the body.
